(19) United States
(12) Patent Application Publication
(10) Pub. No.: US 2019/0070929 A1
(43) Pub. Date: Mar. 7, 2019

(54) AIR-CONDITIONING DEVICE

(71) Applicant: CALSONIC KANSEI CORPORATION, Saitama-shi, Saitama (JP)

(72) Inventors: Kojiro NAKAMURA, Saitama-shi, Saitama (JP); Tomohiro MAEDA, Saitama-shi, Saitama (JP)

(73) Assignee: CALSONIC KANSEI CORPORATION, Saitama-shi, Saitama (JP)

(21) Appl. No.: 16/084,213

(22) PCT Filed: Mar. 8, 2017
(86) PCT No.: PCT/JP2017/009236

§ 371 Date: Sep. 11, 2018

(30) Foreign Application Priority Data
Mar. 14, 2016 (JP) 2016-049837

(51) Int. Cl. B60H 1/22; B60H 1/32

(52) U.S. Cl. CPC B60H 1/22; B60H 1/32; B60H 2001/2268; B60H 2001/2246; B60H 2001/2228

(57) ABSTRACT

An air-conditioning device includes: a compressor, an external heat exchanger, an evaporator, a fluid-cooled condenser, a thermostatic expansion valve, an internal heat exchanger, a fixed restrictor, a first flow-path switching valve, and a second flow-path switching valve configured to switch flow path of cooling medium so as to bypass the fluid-cooled condenser and the fixed restrictor at cabin-cooling operation time.

### TECHNICAL FIELD

The present invention relates to an air-conditioning device.

### BACKGROUND ART

JP2012-176658A discloses a vehicle air-conditioning device including an expansion valve that depressurizes cooling medium flowing into an evaporator, and an internal heat exchanger that performs heat exchange between the cooling medium on the upstream side of the expansion valve and the cooling medium on the downstream side of the evaporator. With the vehicle air-conditioning device disclosed in JP2012-176658A, cabin-cooling operation and cabin-heating operation are performed by switching flow of the cooling medium in a heat pump cycle. In the vehicle air-conditioning device disclosed in JP2012-176658A, it is conceivable that a fixed restrictor, such as a common orifice or capillary tube, is used as the expansion valve. In the case in which the fixed restrictor is used as the expansion valve as described above, the amount of restriction is set small in advance so as not to cause a choked flow when load of the compressor is increased.

In addition, when the fixed restrictor the amount of restriction of which is set small in advance is used as the expansion valve, because the resistance through the expansion valve is decreased, the cooling medium flows through the expansion valve more easily. Therefore, with the vehicle air-conditioning device according to JP2012-176658A, the amount of the cooling medium flowing through the expansion valve is increased, and as a result, it is necessary to increase the amount of the charged-cooling medium to be charged in a cooling medium flow path.

### SUMMARY OF INVENTION

However, in the vehicle air-conditioning device disclosed in JP2012-176658A, it is conceivable that the fixed restrictor the opening degree of which is always constant is used as the expansion valve, and because the amount of restriction of the expansion valve is set small so as not to cause the choked flow when the load of the compressor is increased, the amount of the cooling medium flowing therethrough is greater than that is required, and so, it is not possible to perform cabin-cooling operation with high efficiency.

In addition, as the amount of the charged-cooling medium is increased, when the heat pump operation mode is switched from the cabin-cooling operation to the cabin-heating operation, the pressure difference of the cooling medium between the upstream side and the downstream side of a solenoid valve for switching the flow path is increased. In the case in which the pressure difference between the upstream side and the downstream side of the solenoid valve is large, the solenoid valve cannot be opened due to the increased load, and it is required to wait for a long period of time until the pressure is equalized to a state in which switching action is enabled.

An object of the present invention is to provide an air-conditioning device that is capable of shortening switching time required to switch the heat pump operation mode from the cabin-cooling operation to the cabin-heating operation and that is capable of performing cabin-cooling operation with high efficiency.

According to one aspect of the present invention, an air-conditioning device includes a compressor configured to compress cooling medium; an external heat exchanger configured to perform heat exchange between the cooling medium and outside air; an evaporator configured to evaporate the cooling medium by causing the cooling medium to absorb heat of air used for air-conditioning; a heating device configured to heat the air used for the air-conditioning by using heat of the cooling medium that has been compressed in the compressor; a thermostatic expansion valve arranged between the external heat exchanger and the evaporator, the thermostatic expansion valve being configured to adjust an opening degree based on temperature of the cooling medium that has passed through the evaporator and to decompress and expand the cooling medium that has passed through the external heat exchanger; an internal heat exchanger configured to perform the heat exchange between the cooling medium on an upstream side of the thermostatic expansion valve and the cooling medium on a downstream side of the evaporator; a restrictor mechanism arranged between the compressor and the external heat exchanger, the restrictor mechanism being configured to decompress and expand the cooling medium that has been compressed in the compressor; a first flow-path switching valve configured to switch flow path of the cooling medium so as to bypass the evaporator, the thermostatic expansion valve, and the internal heat exchanger at cabin-heating operation time; and a second flow-path switching valve configured to switch the flow path of the cooling medium so as to bypass the heating device and the restrictor mechanism at cabin-cooling operation time.

According to the above-mentioned aspect, when a heat pump operation mode is switched from the cabin-cooling operation to the cabin-heating operation, the heat exchange is performed by the internal heat exchanger between high pressure liquid cooling medium on the upstream side of the thermostatic expansion valve and low pressure gaseous cooling medium on the downstream side of the evaporator. Therefore, even when, due to the increase in the temperature of the gaseous cooling medium on the downstream side of the evaporator, the opening degree of the thermostatic expansion valve is reduced, making it difficult for the cooling medium to flow therethrough, it is possible to promote pressure equalization by reducing the pressure of the liquid cooling medium on the upstream side of the thermostatic expansion valve and by increasing the pressure of the gaseous cooling medium on the downstream side of the evaporator. Thus, it becomes possible to operate a first flow-path switching valve as the pressure difference between the upstream side and the downstream side of the first flow-path switching valve is reduced quickly, and therefore, it is possible to shorten the switching time. In addition, it is possible to perform the cabin-cooling operation with high efficiency by the thermostatic expansion valve. Therefore, it is possible to shorten the switching time required to switch the heat pump operation mode from the cabin-cooling operation to the cabin-heating operation and to perform the cabin-cooling operation with high efficiency.

### BRIEF DESCRIPTION OF DRAWINGS

FIG. 1 is a configuration diagram of an air-conditioning device according to an embodiment of the present invention.

FIG. 2 is a diagram for explaining a cabin-cooling operation of a heat pump operation mode of the air-conditioning device.

FIG. 3 is a diagram for explaining a cabin-heating operation of the heat pump operation mode of the air-conditioning device.

FIG. 4 is a property table showing a relationship between the saturation temperature and the pressure of cooling medium.

FIG. 5 is a configuration diagram of the air-conditioning device according to a modification of the embodiment of the present invention.

FIG. 6 is a configuration diagram of the air-conditioning device according to another modification of the embodiment of the present invention.

### DESCRIPTION OF EMBODIMENTS

An embodiment of the present invention will be described below with reference to the drawings.

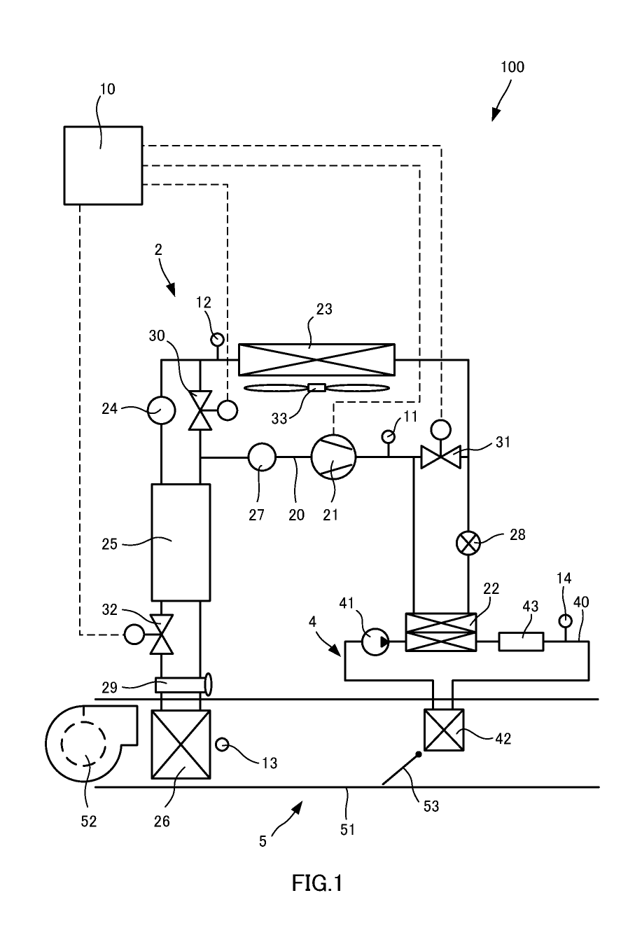

FIG. 1 is a configuration diagram showing an air-conditioning device 100 according to an embodiment of the present invention.

The air-conditioning device 100 is a heat pump system capable of performing cabin cooling and cabin heating and includes a refrigeration cycle 2 through which cooling medium circulates, a high-water temperature cycle 4 through which hot water circulates, an HVAC (Heating Ventilation and Air Conditioning) unit 5 through which air used for air-conditioning passes, and a controller 10 serving as a control unit that controls operation of the air-conditioning device 100. For example, the air-conditioning device 100 is mounted on a vehicle and performs air-conditioning in a vehicle cabin. In addition, HFC-134a is used as the cooling medium, and an antifreeze is used as the hot water.

The refrigeration cycle 2 includes a compressor 21, a fluid-cooled condenser 22, an external heat exchanger 23, a liquid tank 24, an internal heat exchanger 25, an evaporator 26, an accumulator 27, and a cooling medium flow path 20 that connects these components such that the cooling medium can circulates therethrough.

The compressor 21 sucks and compresses gaseous cooling medium. Thus, the temperature and the pressure of the gaseous cooling medium become high.

The fluid-cooled condenser 22 functions as a condenser with which the cooling medium that has passed through the compressor 21 is condensed when a heat pump operation mode is a cabin-heating operation. The fluid-cooled condenser 22 performs heat exchange between the cooling medium the temperature and the pressure of which have been increased by the compressor 21 and the hot water circulating through the high-water temperature cycle 4, thereby transferring the heat of the cooling medium to the hot water. By doing so, the heat for heating the air used for vehicle-cabin air-conditioning is secured in the high-water temperature cycle 4.

The external heat exchanger 23 is provided in an engine compartment of a vehicle, for example (in a motor compartment of an electric car), and performs heat exchange between the cooling medium and outside air. The external heat exchanger 23 functions as a condenser at cabin-cooling time and functions as an evaporator at cabin-heating time. The outside air is introduced into the external heat exchanger 23 as the vehicle is traveled or an external fan 33 is rotated.

At the cabin-cooling time, the liquid tank 24 temporarily stores the cooling medium that has passed through the external heat exchanger 23 and that has been condensed, and performs gas/liquid separation of the cooling medium into the gaseous cooling medium and the liquid cooling medium. Only the separated liquid cooling medium flows into the internal heat exchanger 25 from the liquid tank 24.

The internal heat exchanger 25 performs the heat exchange by using the temperature difference between the cooling medium on the upstream side of a thermostatic expansion valve 29 and the cooling medium on the downstream side of the evaporator 26.

The evaporator 26 is arranged in the HVAC unit 5, and at the cabin-cooling time, the evaporator 26 evaporates the cooling medium by causing the cooling medium to absorb the heat of the air passing through the evaporator 26. The cooling medium evaporated by the evaporator 26 flows into the accumulator 27 through the internal heat exchanger 25.

The accumulator 27 temporarily stores the cooling medium flowing in the cooling medium flow path 20 and performs the gas/liquid separation of the cooling medium into the gaseous cooling medium and the liquid cooling medium. Only the separated gaseous cooling medium flows into the compressor 21 from the accumulator 27. The circulating amount of the cooling medium is less at the cabin-heating operation time than at a cabin-cooling operation time. Therefore, when the cooling medium is charged in the same cooling medium flow path 20, the amount of the cooling medium tends to be excessive at the cabin-heating operation time than at the cabin-cooling operation time. Thus, the accumulator 27 is formed so as to have a volume larger than that of the liquid tank 24.

The cooling medium flow path 20 is provided with a fixed restrictor 28 that causes the cooling medium to be decompressed and expanded and the thermostatic expansion valve 29. In addition, the cooling medium flow path 20 is provided with a first flow-path switching valve 30, a second flow-path switching valve 31, and a third flow-path switching valve 32 that respectively switch the flows of the cooling medium by being opened/closed.

The fixed restrictor 28 is a restrictor mechanism that is arranged between the fluid-cooled condenser 22 and the external heat exchanger 23 and that causes the cooling medium that has been condensed in the fluid-cooled condenser 22 to be decompressed and expanded. As the fixed restrictor 28, for example, an orifice or a capillary tube may be used, and the amount of restriction is set so as to cope with, in advance, specific operation conditions that are used frequently. Instead of using the fixed restrictor 28, for example, a solenoid valve capable of performing stepwise or continuous adjustment of the opening degree may also be used as a variable restrictor.

The thermostatic expansion valve 29 is arranged between the internal heat exchanger 25 and the evaporator 26 and causes the liquid cooling medium that has passed through the internal heat exchanger 25 to be decompressed and expanded. The thermostatic expansion valve 29 automatically adjusts its opening degree on the basis of the temperature of the cooling medium that has passed through the evaporator 26, in other words, on the basis of degree of superheat of the gaseous cooling medium. When the load of the evaporator 26 is increased, the degree of superheat of the gaseous cooling medium is increased. As a result, the opening degree of the thermostatic expansion valve 29 is increased to increase the amount of the cooling medium so as to adjust the degree of superheat. On the other hand, when the load of the evaporator 26 is decreased, the degree of superheat of the gaseous cooling medium is decreased. As a result, the opening degree of the thermostatic expansion valve 29 is decreased to the amount of the cooling medium so as to adjust the degree of superheat. As described above, the thermostatic expansion valve 29 performs feedback of the temperature of the adjusting the opening degree such that the degree of superheat of the gaseous cooling medium becomes suitable. By employing the thermostatic expansion valve 29 on the upstream side of the evaporator 26, the flowing amount of the cooling medium does not have to be unnecessarily increased compared to the case in which the fixed restrictor having a small amount of restriction is employed in order to cope with a wide range of heat load, and thereby, the amount of the cooling medium to be charged in the cooling medium flow path 20 becomes less.

The first flow-path switching valve 30 is opened at the cabin-heating time and is closed at the cabin-cooling time. As the first flow-path switching valve 30 is opened, the cooling medium that has been evaporated in the external heat exchanger 23 flows directly into the accumulator 27 by bypassing the liquid tank 24, the internal heat exchanger 25, the thermostatic expansion valve 29, and the evaporator 26.

The second flow-path switching valve 31 and the third flow-path switching valve 32 are opened at the cabin-cooling time and are closed at the cabin-heating time. As the second flow-path switching valve 31 is opened, the cooling medium that has been compressed in the compressor 21 flows directly into the external heat exchanger 23. In addition, as the third flow-path switching valve 32 is opened, the liquid cooling medium that has passed through the internal heat exchanger 25 flows into the evaporator 26.

The high-water temperature cycle 4 includes a water pump 41, a heater core 4, an auxiliary heating device 43, the fluid-cooled condenser 22, and a hot water flow path 40 that connects these components such that the hot water can circulates therethrough.

The water pump 41 pumps the hot water in the hot water flow path 40 so as to circulate the hot water therethrough.

The heater core 42 is arranged in the HVAC unit 5, and at the cabin-heating time, heats the air passing through the heater core 42 by causing the air to absorb the heat of the hot water.

The auxiliary heating device 43 has an inner heater (not shown) to heat the hot water passing therethrough. As the heater, for example, a sheathed heater or a PTC (Positive Temperature Coefficient) heater may be used.

The HVAC unit 5 cools or heats the air used for the air-conditioning. The HVAC unit 5 is provided with a blower 52 that sends the air, an air mix door 53 that adjusts the amount of the air passing through the heater core 42, and a case 51 that surrounds these components such that the air used for the air-conditioning can pass through. The evaporator 26 and the heater core 42 are arranged in the HVAC unit 5, and the air sent from the blower 52 is subjected to the heat exchange with the cooling medium flowing in the evaporator 26 and/or the hot water flowing in the heater core 42.

The air mix door 53 is arranged on the blower 52 side of the heater core 42 that is arranged in the HVAC unit 5. The air mix door 53 opens the heater core 42 side at the cabin-heating time and closes the heater core 42 side at the cabin-cooling time. Depending on the opening degree of the air mix door 53, the amount of the heat exchange performed between the air and the hot water in the heater core 42 is adjusted.

The air-conditioning device 100 is provided with a discharge pressure sensor 11, an external heat-exchanger-exit temperature sensor 12, an evaporator temperature sensor 13, and a water temperature sensor 14.

The discharge pressure sensor 11 is arranged on the discharge side of the compressor 21 in the cooling medium flow path 20 and detects the pressure of the gaseous cooling medium that has been compressed in the compressor 21.

The external heat-exchanger-exit temperature sensor 12 is arranged in the vicinity of an exit of the external heat exchanger 23 in the cooling medium flow path 20 and detects the temperature of the cooling medium that has passed through the external heat exchanger 23. The external heat-exchanger-exit temperature sensor 12 may also be arranged at the exit portion of the external heat exchanger 23.

The evaporator temperature sensor 13 is arranged on the downstream side of the air flow of the evaporator 26 in the HVAC unit 5 and detects the temperature of the air that has passed through the evaporator 26. The temperature of the air that has passed through the evaporator 26 is substantially the same as the temperature of the cooling medium immediately after discharged from the evaporator 26. The evaporator temperature sensor 13 may be arranged directly on the evaporator 26.

The water temperature sensor 14 is arranged in the vicinity of an exit of the auxiliary heating device 43 in the hot water flow path 40 and detects the temperature of the hot water that has passed through the auxiliary heating device 43.

The controller 10 includes a CPU (Central Processing Unit), a ROM (Read Only Memory), a RAM (Random Access Memory), and so forth, and various functions of the air-conditioning device 100 are exhibited by reading out programs stored in the ROM with the CPU. Signals from the discharge pressure sensor 11, the external heat-exchanger-exit temperature sensor 12, the evaporator temperature sensor 13, and the water temperature sensor 14 are input to the controller 10. Signals from an outside-air temperature sensor (not shown) etc. may also be input to the controller 10.

The controller 10 performs control of the refrigeration cycle 2 on the basis of the input signals. In other words, as shown by broken lines in FIG. 1, the controller 10 sets the output of the compressor 21 and performs open/close control of the first flow-path switching valve 30, the second flow-path switching valve 31, and the third flow-path switching valve 32. In addition, the controller 10 also performs control of the high-water temperature cycle 4 and the HVAC unit 5 by sending output signals (not shown).

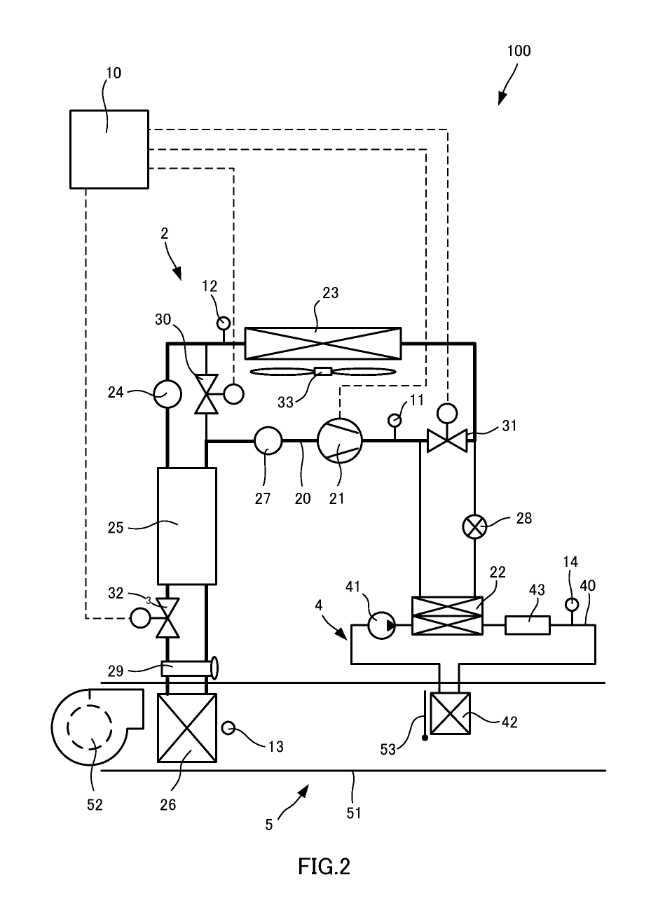

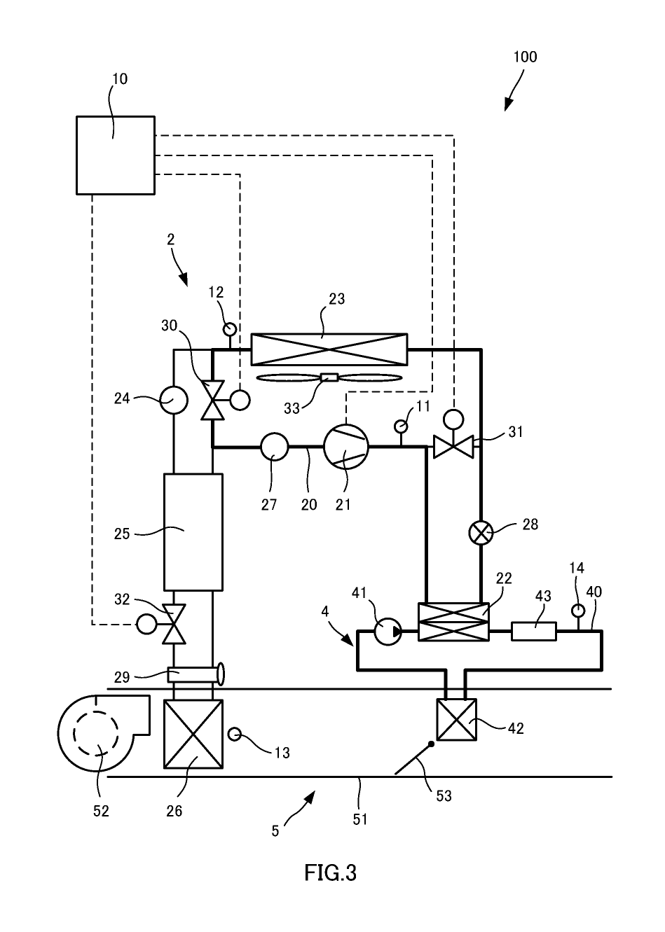

Next, the cabin-cooling operation and the cabin-heating operation of the heat pump operation mode of the air-conditioning device 100 will be described with reference to FIGS. 2 and 3.

<Cabin-Cooling Operation>

FIG. 2 is a diagram for explaining the cabin-cooling operation of the heat pump operation mode of the air-conditioning device 100. In the cabin-cooling operation, the cooling medium in the cooling medium flow path 20 circulates as shown by thick-solid line in FIG. 2.

The controller 10 closes the first flow-path switching valve 30, and opens the second flow-path switching valve 31 and the third flow-path switching valve 32. By doing so, the high-pressure high-temperature cooling medium that has been compressed in the compressor 21 flows to the external heat exchanger 23 through the second flow-path switching valve 31. The cooling medium that has reached the external heat exchanger 23 is cooled by being subjected to the heat exchange with the outside air introduced to the external heat exchanger 23, and thereafter, subjected to the gas/liquid separation through the liquid tank 24. The liquid cooling medium obtained from the cooling medium subjected to the gas/liquid separation in the liquid tank 24 flows through the internal heat exchanger 25 that is connected to the downstream side of the liquid tank 24.

Subsequently, the liquid cooling medium flows into the evaporator 26 after being decompressed and expanded in the thermostatic expansion valve 29, and the liquid cooling medium is evaporated by absorbing the heat of the air used for the air-conditioning while passing through the evaporator 26. At this time, because the liquid cooling medium is supercooled so as to reach a supercooled state, it is possible to further cool the air flowing along the evaporator 26. The liquid cooling medium is evaporated to become the gaseous cooling medium, and as described below, the gaseous cooling medium reaches a superheated state while flowing through the internal heat exchanger 25, and thereafter, the gaseous cooling medium flows into the compressor 21 again through the accumulator 27 and is compressed in the compressor 21.

The liquid cooling medium flowing from the liquid tank 24 to the internal heat exchanger 25 is a high-pressure fluid and is in a substantially saturated liquid state at which a degree of supercool is about 0° C. after being subjected to the gas/liquid separation in the liquid tank 24. On the other hand, the gaseous cooling medium flowing from the evaporator 26 to the internal heat exchanger 25 is a low-temperature fluid by being decompressed and expanded while flowing through the thermostatic expansion valve 29. Therefore, the liquid cooling medium is subjected to the heat exchange with the low-temperature gaseous cooling medium while flowing through the internal heat exchanger 25, and the liquid cooling medium reaches the supercooled state with the degree of supercool from the saturated liquid state by being supercooled by the gaseous cooling medium. In addition, the gaseous cooling medium reaches the superheated state with the degree of superheat by being heated by the liquid cooling medium while flowing through the internal heat exchanger 25.

The air that has been cooled with the cooling medium in the evaporator 26 is used as cabin cooling wind by flowing towards the downstream side of the HVAC unit 5. After water vapor in the air is condensed and removed by cooling the air by the evaporator 26, the air can be reheated by the heater core 42, and thereby, dehumidified wind can also be obtained (dehumidificating operation).

<Cabin-Heating Operation>

FIG. 3 is a diagram for explaining the cabin-heating operation of the heat pump operation mode of the air-conditioning device 100. In the cabin-heating operation, so called outside-air heat-absorbing heat pump operation is performed, and the cooling medium in the cooling medium flow path 20 and the hot water in the hot water flow path 40 respectively circulate as shown by the thick-solid line in FIG. 3.

The controller 10 closes the second flow-path switching valve 31 and the third flow-path switching valve 32, and opens the first flow-path switching valve 30. By doing so, the high-temperature cooling medium that has been compressed in the compressor 21 flows to the fluid-cooled condenser 22. The cooling medium that has reached the fluid-cooled condenser 22 becomes low temperature as the heat thereof is taken away while heating the hot water in the fluid-cooled condenser 22. Thereafter, the temperature of the cooling medium is further decreased by being decompressed and expanded by passing through the fixed restrictor 28, and then, flows to the external heat exchanger 23. The cooling medium that has reached the external heat exchanger 23 is subjected to the heat exchange with the outside air introduced to the external heat exchanger 23 and absorbs the heat. Thereafter, the cooling medium is subjected to the gas/liquid separation by flowing into the accumulator 27 via the first flow-path switching valve 30. The gaseous cooling medium obtained from the cooling medium subjected to the gas/liquid separation in the accumulator 27 flows again to the compressor 21.

On the other hand, the hot water that has been heated with the cooling medium in the fluid-cooled condenser 22 circulates and flows into the heater core 42, thereby heating the surrounding air of the heater core 42. Thus-heated air flows towards the downstream side of the HVAC unit 5 and is used as a cabin heating wind. In the case in which the hot water cannot be heated sufficiently with the cooling medium in the fluid-cooled condenser 22, the hot water may be heated by operating the auxiliary heating device 43 independently or in combination with the outside-air heat-absorbing heat pump operation.

Next, a switching control of the heat pump operation mode between the cabin-cooling operation and the cabin-heating operation performed by the controller 10 will be described.

<Switching Control from Cabin-Cooling Operation to Cabin-Heating Operation>

In the switching control from the cabin-cooling operation to the cabin-heating operation, the controller 10 stops the compressor 21, closes the second flow-path switching valve 31 and the third flow-path switching valve 32, and opens the first flow-path switching valve 30, thereby switching the flow of the cooling medium flowing through the cooling medium flow path 20.

In the case in which the pressure difference between the cooling medium on the upstream side of the first flow-path switching valve 30 and the cooling medium on the downstream side of the first flow-path switching valve 30 is exceeding a first operation-allowable pressure that allows the operation of the first flow-path switching valve 30, operation load required for the first flow-path switching valve 30 becomes larger than the torque of the first flow-path switching valve 30. In addition, if the first flow-path switching valve 30 is forcedly operated to open it when the operation load required for the first flow-path switching valve 30 is large, there is a risk in that excessive load is exerted on the first flow-path switching valve 30 and the durability thereof may be deteriorated. In addition, if the first flow-path switching valve 30 is switched in the state in which the pressure difference is large, a large noise is caused by the flowing cooling medium. Thus, the controller 10 determines whether or not the pressure difference of the cooling medium between the upstream side and the downstream side of the first flow-path switching valve 30 falls within the first operation-allowable pressure range.

The pressure of the cooling medium on the upstream side of the first flow-path switching valve 30 is equivalent to the pressure of the cooling medium on the upstream side of the thermostatic expansion valve 29, and it has become high pressure by being compressed in the compressor 21. The pressure of the cooling medium on the upstream side of the first flow-path switching valve 30 is detected by the discharge pressure sensor 11.

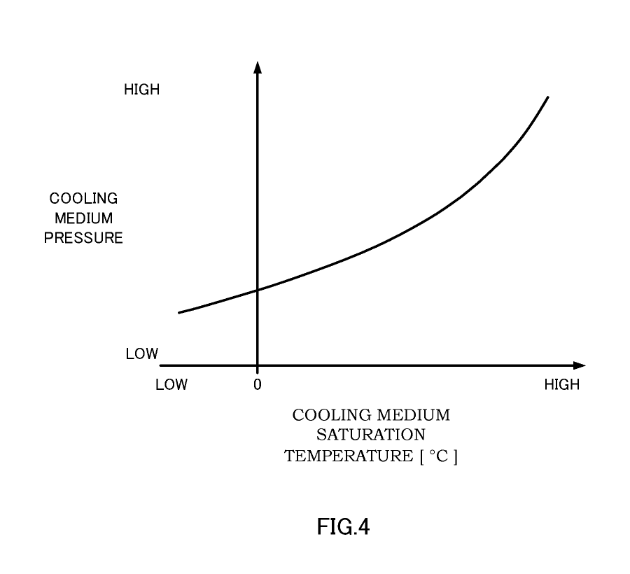

The pressure of the cooling medium on the downstream side of the first flow-path switching valve 30 is equivalent to the pressure of the cooling medium on the downstream side of the thermostatic expansion valve 29, and it has become low pressure by being decompressed and expanded at the thermostatic expansion valve 29. The pressure of the cooling medium on the downstream side of the first flow-path switching valve 30 is obtained by referring to a property table shown in FIG. 4 with the controller 10 on the basis of the temperature of the air detected by the evaporator temperature sensor 13. FIG. 4 is the property table showing the relationship between the saturation temperature and the pressure of the cooling medium. The horizontal axis in FIG. 4 is taken as the saturation temperature of the cooling medium, and the vertical axis is taken as the pressure of the cooling medium. As shown in FIG. 4, the pressure of the cooling medium is increased sharply as the saturation temperature of the cooling medium increases. The pressure of the cooling medium on the downstream side of the first flow-path switching valve 30 is substantially the same as the pressure of the cooling medium that has been evaporated and saturated in the evaporator 26 after being decompressed and expanded at the thermostatic expansion valve 29. In addition, the temperature of the air on the downstream side of the evaporator 26 is substantially the same as the temperature of the cooling medium immediately after discharged from the evaporator 26. Therefore, by referring to the property table shown in FIG. 4, the controller 10 can obtain the pressure of the cooling medium on the downstream side of the first flow-path switching valve 30 from the temperature of the air detected by the evaporator temperature sensor 13.

The controller 10 calculates the pressure difference of the cooling medium between the upstream side and the downstream side of the first flow-path switching valve 30 from the pressure of the cooling medium on the upstream side of the first flow-path switching valve 30 and the pressure of the cooling medium on the downstream side of the first flow-path switching valve 30.

When the pressure difference of the cooling medium between the upstream side and the downstream side of the first flow-path switching valve 30 is greater than a predetermined pressure, the controller 10 prohibits the switching of the flow path of the cooling medium by the first flow-path switching valve 30. Because the compressor 21 is stopped while the switching of the first flow-path switching valve 30 is prohibited, the pressure difference of the cooling medium between the upstream side and the downstream side of the first flow-path switching valve 30 is gradually equalized.

When the pressure equalization is achieved, the compressor 21 is stopped and the property of the cooling medium at the exit of the evaporator 26 tends to shift along the saturation line (the degree of superheat 0), and thereby, the thermostatic expansion valve 29 is shifted in the closing direction such that the degree of superheat is increased. Therefore, it becomes more difficult for the high-pressure liquid cooling medium on the upstream side of the thermostatic expansion valve 29 to flow to the downstream side through the thermostatic expansion valve 29, and therefore, longer time is required to increase the pressure of the low-pressure gaseous cooling medium on the downstream side.

However, in this embodiment, with the internal heat exchanger 25, the low-pressure gaseous cooling medium on the downstream side of the thermostatic expansion valve 29 is expanded by being subjected to the heat exchange with the high-pressure liquid cooling medium on the upstream side of the thermostatic expansion valve 29, and thereby, the pressure of the gaseous cooling medium is increased at an early stage. In addition, the pressure of the liquid cooling medium is decreased at an early stage by being cooled by the gaseous cooling medium.

Furthermore, in this embodiment, the liquid tank 24 is arranged on the upstream side of the thermostatic expansion valve 29, and the accumulator 27 having larger volume than the liquid tank 24 is arranged on the downstream side the thermostatic expansion valve 29. Therefore, as compared with the case in which the accumulator 27 is not arranged on the downstream side of the thermostatic expansion valve 29 and the liquid tank 24 is also used as the accumulator, the volume of the liquid tank 24 is reduced and the amount of the charged cooling medium on the upstream side is reduced in this embodiment. Therefore, on the upstream side of the thermostatic expansion valve 29, because the amount of the liquid cooling medium gasified is reduced by an amount corresponding to the reduced amount of the volume of the liquid tank 24, it is possible to suppress the pressure on the upstream side of the first flow-path switching valve 30 from being maintained at a high-pressure state. Therefore, even when the environmental load is low and the liquid cooling medium tends to be accumulated, it is possible to reduce the pressure of the high-pressure liquid cooling medium on the upstream side of the first flow-path switching valve 30 at an early stage.

By performing the pressure equalization, when the pressure difference of the cooling medium between the upstream side and the downstream side of the first flow-path switching valve 30 is equal to or less than the predetermined pressure, the controller 10 permits the switching of the flow path of the cooling medium by the first flow-path switching valve 30.

When the opening operation of the first flow-path switching valve 30 is permitted, the second flow-path switching valve 31 and the third flow-path switching valve 32 are closed and the first flow-path switching valve 30 is opened, and thereby, the flow of the cooling medium flowing through the cooling medium flow path 20 is switched to switch the heat pump operation mode from the cabin-cooling operation to the cabin-heating operation.

<Switching Control from Cabin-Heating Operation to Cabin-Cooling Operation>

In the switching control from the cabin-heating operation to the cabin-cooling operation, the controller 10 stops the compressor 21, closes the first flow-path switching valve 30, and opens the second flow-path switching valve 31 and the third flow-path switching valve 32, and thereby, the flow of the cooling medium flowing through the cooling medium flow path 20 is switched.

Here, in the case in which the pressure difference between the cooling medium on the upstream side of the second flow-path switching valve 31 and the cooling medium on the downstream side of the second flow-path switching valve 31 is exceeding a second operation-allowable pressure that allows the operation of the second flow-path switching valve 31, similarly to the case for the first flow-path switching valve 30 described above, the controller 10 cannot open the second flow-path switching valve 31. Therefore, in order to open the second flow-path switching valve 31, the controller 10 determines whether or not the pressure difference of the cooling medium between the upstream side and the downstream side of the second flow-path switching valve 31 is equal to or less than the second operation-allowable pressure.

The pressure of the cooling medium on the upstream side of the second flow-path switching valve 31 is detected by the discharge pressure sensor 11, and the pressure of the cooling medium on the downstream side of the second flow-path switching valve 31 is obtained on the basis of the temperature detected by the external heat-exchanger-exit temperature sensor 12. By referring to the property table shown in FIG. 4, the controller 10 obtains the pressure of the cooling medium on the downstream side of the second flow-path switching valve 31. The pressure of the cooling medium on the downstream side of the second flow-path switching valve 31 is substantially the same as the cooling medium that has been evaporated and saturated in the external heat exchanger 23 after being decompressed and expanded in the fixed restrictor 28. Therefore, by referring to the property table shown in FIG. 4, the controller 10 can obtain the pressure of the cooling medium on the downstream side of the second flow-path switching valve 31 from the temperature of the cooling medium detected by the external heat-exchanger-exit temperature sensor 12.

Similarly, in order to open the third flow-path switching valve 32, the pressure difference of the cooling medium between the upstream side and the downstream side of the third flow-path switching valve 32 needs to be equal to or less than the predetermined pressure. However, the cooling medium on the upstream side and the downstream side of the third flow-path switching valve 32 does not circulate through the cooling medium flow path 20 during the cabin-heating operation. Therefore, the pressure equalization is performed gradually during the cabin-heating operation via the thermostatic expansion valve 29 and the released second flow-path switching valve 31. Therefore, in the case in which the second flow-path switching valve 31 falls within the second operation-allowable pressure range, because the pressure difference of the cooling medium between the upstream side and the downstream side of the third flow-path switching valve 32 is normally equal to or less than the predetermined pressure, the controller 10 only needs to perform the determination on the pressure difference of the cooling medium between the upstream side and the downstream side of the second flow-path switching valve 31.

In the case in which the pressure difference of the cooling medium between the upstream side and the downstream side of the second flow-path switching valve 31 is greater than the predetermined pressure, the controller 10 prohibits the switching of the flow path of the cooling medium by the second flow-path switching valve 31. Because the compressor 21 is stopped while the switching of the second flow-path switching valve 31 is prohibited, the pressure difference of the cooling medium between the upstream side and the downstream side of the second flow-path switching valve 31 is gradually equalized.

By performing the pressure equalization, when the pressure difference of the cooling medium between the upstream side and the downstream side of the second flow-path switching valve 31 is equal to or less than the predetermined pressure, the controller 10 permits the switching of the flow path of the cooling medium by the second flow-path switching valve 31.

Subsequently, by closing the first flow-path switching valve 30 and by opening the second flow-path switching valve 31 and the third flow-path switching valve 32, the flow of the cooling medium flowing through the cooling medium flow path 20 is switched to switch the heat pump operation mode from the cabin-heating operation to the cabin-cooling operation.

According to the embodiment mentioned above, the advantages described below are afforded.

The air-conditioning device 100 includes: the compressor 21 configured to compress the cooling medium; the external heat exchanger 23 configured to perform the heat exchange between the cooling medium and the outside air; the evaporator 26 configured to cause the cooling medium to absorb the heat of the air used for the air-conditioning; the fluid-cooled condenser 22 configured to heat the air used for the air-conditioning by using the heat of the cooling medium that has been compressed in the compressor 21; the thermostatic expansion valve 29 arranged between the external heat exchanger 23 and the evaporator 26, the thermostatic expansion valve 29 being configured to adjust the opening degree based on the temperature of the cooling medium that has passed through the evaporator 26 and to decompress and expand the cooling medium that has passed through the external heat exchanger 23; the internal heat exchanger 25 configured to perform the heat exchange between the cooling medium on the upstream side of the thermostatic expansion valve 29 and the cooling medium on the downstream side of the evaporator 26; the fixed restrictor 28 arranged between the compressor 21 and the external heat exchanger 23, the fixed restrictor 28 being configured to decompress and expand the cooling medium that has been compressed in the compressor 21; the first flow-path switching valve 30 configured to switch the flow path of the cooling medium so as to bypass the evaporator 26 and the thermostatic expansion valve 29 at the cabin-heating operation time; and the second flow-path switching valve 31 configured to switch the flow path of the cooling medium so as to bypass the fluid-cooled condenser 22 and the fixed restrictor 28 at the cabin-cooling operation time.

According to the air-conditioning device 100 having such a configuration, when the heat pump operation mode is switched from the cabin-cooling operation to the cabin-heating operation, the internal heat exchanger 25 performs the heat exchange between the high-pressure liquid cooling medium on the upstream side of the thermostatic expansion valve 29 and the low-pressure gaseous cooling medium on the downstream side of the evaporator 26. Therefore, the temperature of the gaseous cooling medium on the downstream side of the evaporator 26 is increased, and even when the opening degree of the thermostatic expansion valve 29 is reduced, making it difficult for the cooling medium to flow therethrough, it is possible to promote the pressure equalization by reducing the pressure of the liquid cooling medium on the upstream side of the thermostatic expansion valve 29 and by increasing the pressure on the gaseous cooling medium of the downstream side of the evaporator 26. Thus, because it becomes possible to operate the first flow-path switching valve 30 as the pressure difference of the cooling medium between the upstream side and the downstream side of the first flow-path switching valve 30 is reduced quickly, it is possible to shorten the switching time. In addition, by using the thermostatic expansion valve 29, it is possible to perform the cabin-cooling operation with high efficiency. Therefore, it is possible to shorten the switching time required to switch the heat pump operation mode from the cabin-cooling operation to the cabin-heating operation and to perform the cabin-cooling operation with high efficiency.

With the air-conditioning device 100, the second flow-path switching valve 31 switches the flow path of the cooling medium so as to bypass the evaporator 26 and the thermostatic expansion valve 29 at the cabin-heating operation time. By doing this, as compared with the case in which the evaporator 26 and the thermostatic expansion valve 29 are not bypassed, it is possible to reduce unnecessary pressure loss on the low pressure side, and therefore, it is possible to perform the cabin-heating operation with high efficiency.

The air-conditioning device 100 further includes: the third flow-path switching valve 32 arranged between the internal heat exchanger 25 and the thermostatic expansion valve 29, the third flow-path switching valve 32 being configured to be opened so as to allow the cooling medium to flow into the thermostatic expansion valve 29 at the cabin-cooling operation time. With such a configuration, at the cabin-heating operation time, the cooling medium does not flow into the thermostatic expansion valve 29 and the evaporator 26, and it is possible to perform the cabin-heating operation at high efficiency.

The air-conditioning device 100 further includes the controller 10 serving as a control unit configured to control the operation of the first flow-path switching valve 30 and the second flow-path switching valve 31. The controller 10 permits the switching of the flow path of the cooling medium by the first flow-path switching valve 30 and the second flow-path switching valve 31 in the case in which the pressure difference between the cooling medium on the upstream side of the compressor 21 and the cooling medium on the downstream side of the compressor 21 is equal to or less than the predetermined pressure. As a result, exertion of the excessive load on the first flow-path switching valve 30 and the second flow-path switching valve 31 is prevented, and it is possible to improve the durability and to suppress the noise caused by the flowing cooling medium.

At the time of the switching control from the cabin-cooling operation to the cabin-heating operation, the controller 10 may not wait until the pressure is equalized and may close the second flow-path switching valve 31, which is open, before the pressure is equalized. When the second flow-path switching valve 31 is open, because there is no pressure difference between the upstream side and the downstream side of the second flow-path switching valve 31, the second flow-path switching valve 31 can be closed without load. In addition, by closing the second flow-path switching valve 31, the first flow-path switching valve 30 is prevented from directly receiving the pressure of the cooling medium from the compressor 21 to the fixed restrictor 28 at the upstream side of the first flow-path switching valve 30, and therefore, it is possible to reduce the pressure on the upstream side of the first flow-path switching valve 30 at early stage.

Although the embodiment of the present invention has been described above, the above-mentioned embodiment is only an illustration of a part of application examples of the present invention, and there is no intention to limit the technical scope the present invention to the specific configuration of the above-mentioned embodiment.

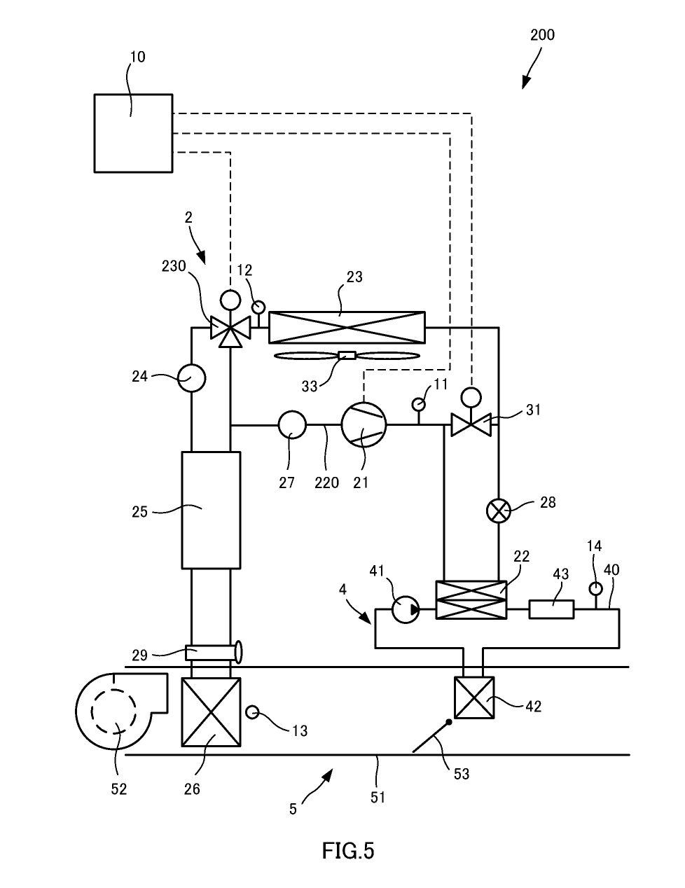

For example, as shown in FIG. 5, a first flow-path switching valve of an air-conditioning device 200 may be a three-way valve 230. FIG. 5 is a configuration diagram of the air-conditioning device 200 according to a modification of the embodiment of the present invention. With such a configuration, it is possible to switch the flow path of the cooling medium so as to bypass the evaporator 26 and the thermostatic expansion valve 29 by the three-way valve 230 alone, and so, the configuration of a cooling medium flow path 220 can be made simpler.

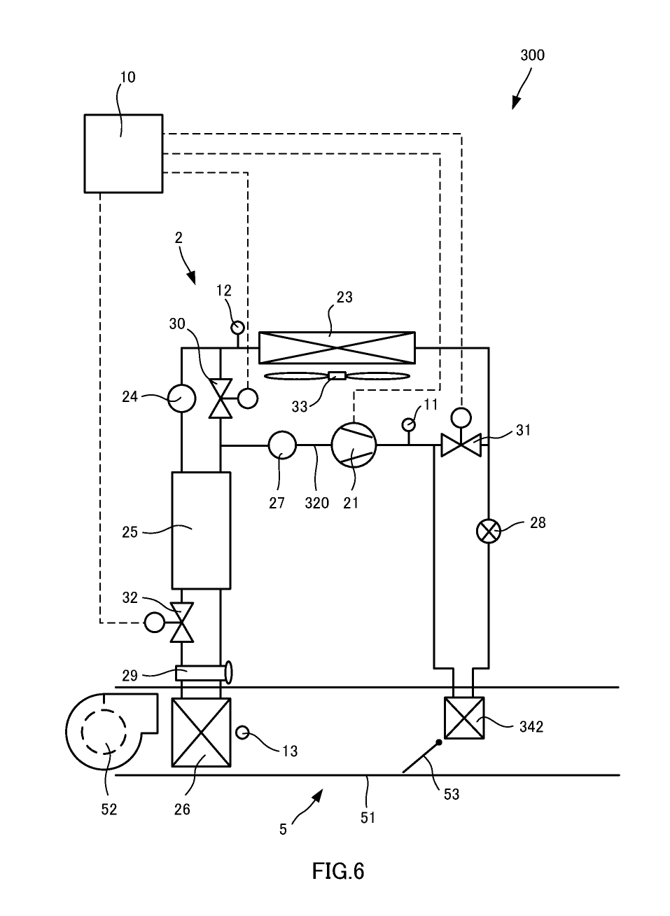

In addition, as shown in FIG. 6, in an air-conditioning device 300, the air used for the air-conditioning may be heated directly by a heater core 342 connected to a cooling medium flow path 320 without utilizing a fluid-cooled condenser. FIG. 6 is a configuration diagram of the air-conditioning device 300 according to another modification of the embodiment of the present invention. According to such a configuration, the configuration of the cooling medium flow path 320 can also be made simpler.

The above-mentioned embodiments may be combined appropriately.

This application claims priority based on Japanese Patent Application No. 2016-049837 filed with the Japan Patent Office on Mar. 14, 2016, the entire contents of which are incorporated into this specification.

1. The air-conditioning device comprising:
a compressor configured to compress cooling medium;
an external heat exchanger configured to perform heat exchange between the cooling medium and outside air;
an evaporator configured to evaporate the cooling medium by causing the cooling medium to absorb heat of air used for air-conditioning;
a heating device configured to heat the air used for the air-conditioning by using heat of the cooling medium that has been compressed in the compressor;
a thermostatic expansion valve arranged between the external heat exchanger and the evaporator, the thermostatic expansion valve being configured to adjust an opening degree based on temperature of the cooling medium that has passed through the evaporator and to decompress and expand the cooling medium that has passed through the external heat exchanger;
an internal heat exchanger configured to perform the heat exchange between the cooling medium on an upstream side of the thermostatic expansion valve and the cooling medium on a downstream side of the evaporator;
a restrictor mechanism arranged between the compressor and the external heat exchanger, the restrictor mechanism being configured to decompress and expand the cooling medium that has been compressed in the compressor;
a first flow-path switching valve configured to switch flow path of the cooling medium so as to bypass the evaporator, the thermostatic expansion valve, and the internal heat exchanger at cabin-heating operation time;
a second flow-path switching valve configured to switch the flow path of the cooling medium so as to bypass the heating device and the restrictor mechanism at cabin-cooling operation time;
a gas/liquid separator arranged between the heating device and the internal heat exchanger, the gas/liquid separator performs gas/liquid separation of the cooling medium; wherein
the cooling medium flows in the order of the compressor, the second flow-path switching valve, the external heat exchanger, the internal heat exchanger, the thermostatic expansion valve, the evaporator, the internal heat exchanger, the gas/liquid separator, the compressor at cabin-cooling operation time, and
the cooling medium flows in the order of the compressor, the heating device, the restrictor mechanism, the external heat exchanger, the first flow-path switching valve, the gas/liquid separator, the compressor at cabin-heating operation time.

2. (canceled)

3. The air-conditioning device according to claim 1, further comprising
an open/close valve arranged between the internal heat exchanger and the thermostatic expansion valve, the open/close valve being configured to be opened so as to allow the cooling medium to flow into the thermostatic expansion valve at the cabin-cooling operation time.

4. The air-conditioning device according to claim 1, wherein
the second flow-path switching valve is a three-way valve configured to switch the flow path of the cooling medium so as to bypass the evaporator and the thermostatic expansion valve.

5. The air-conditioning device according to claim 1, further comprising
a control unit configured to control operation of the first flow-path switching valve and the second flow-path switching valve, wherein
the control unit is configured to permit switching of the flow path of the cooling medium by the first flow-path switching valve and the second flow-path switching valve in a case in which pressure difference between the cooling medium on an upstream side of the compressor and the cooling medium on a downstream side of the compressor is equal to or less than a predetermined pressure.
